(19) United States
(12) Patent Application Publication
(10) Pub. No.: US 2013/0275895 A1
(43) Pub. Date: Oct. 17, 2013

(54) DISPLAY APPARATUS AND CONTROL METHOD THEREOF

(71) Applicant: SAMSUNG ELECTRONICS CO., LTD., Suwon-si (KR)

(72) Inventors: Jung-min KANG, Seoul (KR); Seung-kwon PARK, Yongin-si (KR); Hee-soo LEE, Hwaseong-si (KR)

(73) Assignee: SAMSUNG ELECTRONICS CO., LTD., Suwon-si (KR)

(21) Appl. No.: 13/783,475

(22) Filed: Mar. 4, 2013

(30) Foreign Application Priority Data
Apr. 13, 2012 (KR) 10-2012-0038323

(51) Int. Cl. G06F 3/048

(52) U.S. Cl. CPC G06F 3/048
USPC 715/764

(57) ABSTRACT

A display apparatus and a control method thereof are provided. The display apparatus includes: an image processor, which processes an image signal; a display unit, which displays an image based on the image signal and a user interface (UI) for user interfacing; and a controller, which determines a size of the UI displayed on the display unit for a user currently watching the display apparatus and, which displays the UI in the determined size on the display unit.

### CROSS-REFERENCE TO RELATED APPLICATION

This application claims priority from Korean Patent Application No. 10-2012-0038323, filed on Apr. 13, 2012 in the Korean Intellectual Property Office, the disclosure of which is incorporated herein by reference.

### BACKGROUND

1. Field

Apparatuses and methods consistent with exemplary embodiments relate to a display apparatus and a control method thereof, and more particularly to a display apparatus displaying a user interface (UI) for user interfacing and a control method thereof.

2. Description of the Related Art

A display apparatus, such as a TV, a PC, a mobile phone and a smartphone, displays a graphic user interface (hereinafter, referred to as a “UI”) for user interfacing.

A UI is displayed in various forms in a predetermined size, e.g., texts, icons and buttons, for a user to select. However, a determined-size UI may be inconvenient to a user.

For example, when a user is out of visible range or has bad sight, the user may have difficulty in recognizing a text or an icon or make a mistake of choosing a wrong icon or button.

### SUMMARY

Accordingly, one or more exemplary embodiments provide a display apparatus which displays a UI in an appropriate size for a user currently watching the display apparatus, and a control method thereof.

The foregoing and/or other aspects may be achieved by providing a display apparatus including: an image processor which processes an image signal; a display unit which displays an image based on the image signal and a user interface (UI) for user interfacing; and a controller which determines a size of the UI displayed on the display unit for a user currently watching the display apparatus and displaying the UI in the determined size on the display unit.

The controller may determine the size of the UI based on an age of the user.

The display apparatus may further include a recognition unit which recognizes a physical feature of the user, wherein the controller determines the age of the user based on the physical feature of the user.

The display apparatus may further include a user input unit which receives user input, wherein the controller determines the age of the user based on the user input.

The controller may determine the size of the UI further based on complexity of content of the UI.

The controller may determine the size of the UI based on a level of difficulty in manipulating the UI.

The display apparatus may further include a user input unit which receives user input, wherein the controller determines the size of the UI based on the user input.

The display apparatus may further include a storage unit which stores user information on the size of the UI, wherein the controller determines the size of the UI based on the stored user information.

The controller may determine the size of the UI for a user of a higher priority among a plurality of users when the plurality of users watch the display apparatus.

The foregoing and/or other aspects may also be achieved by providing a control method of a display apparatus displaying an image, the control method including: determining a size of a user interface (UI) to be displayed on a display unit for a user currently watching the display apparatus; generating the UI in the determined size; and displaying the UI on the display unit.

The determining the size of the UI may include determining the size of the UI based on an age of the user.

The control method may further include recognizing a physical feature of the user, wherein the determining the size of the UI includes determining the age of the user based on the physical feature of the user.

The control method may further include receiving user input, wherein the determining the size of the UI includes determining the age of the user based on the user input.

The determining the size of the UI may include determining the size of the UI further based on complexity of content of the UI.

The determining the size of the UI may include determining the size of the UI further based on a level of difficulty in manipulating the UI.

The control method may further include receiving user input, wherein the determining the size of the UI includes determining the size of the UI based on the user input.

The control method may further include storing user information on the size of the UI, wherein the determining the size of the UI includes determining the size of the UI based on the stored user information.

The determining the size of the UI may include determining the size of the UI for a user of a higher priority among a plurality of users when the plurality of users watch the display apparatus.

As described above, a display apparatus according to one exemplary embodiment displays a UI in an appropriate size for a user currently watching the display apparatus, thereby enabling the user to conveniently interface and minimizing errors in interfacing.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a display apparatus according to an exemplary embodiment.

FIGS. 2 to 4 are flowcharts showing illustrative control methods of the display apparatus shown in FIG. 1 according to exemplary embodiments.

FIG. 5 shows an illustrative user interface (UI) displayed by the display apparatus of FIG. 1.

FIGS. 6 to 9 are flowcharts showing illustrative control methods of the display apparatus shown in FIG. 1 according to exemplary embodiments.

FIG. 10 shows illustrative user information stored in the display apparatus of FIG. 1.

FIG. 11 is a flowchart showing an illustrative control method of the display apparatus shown in FIG. 1 according to one exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

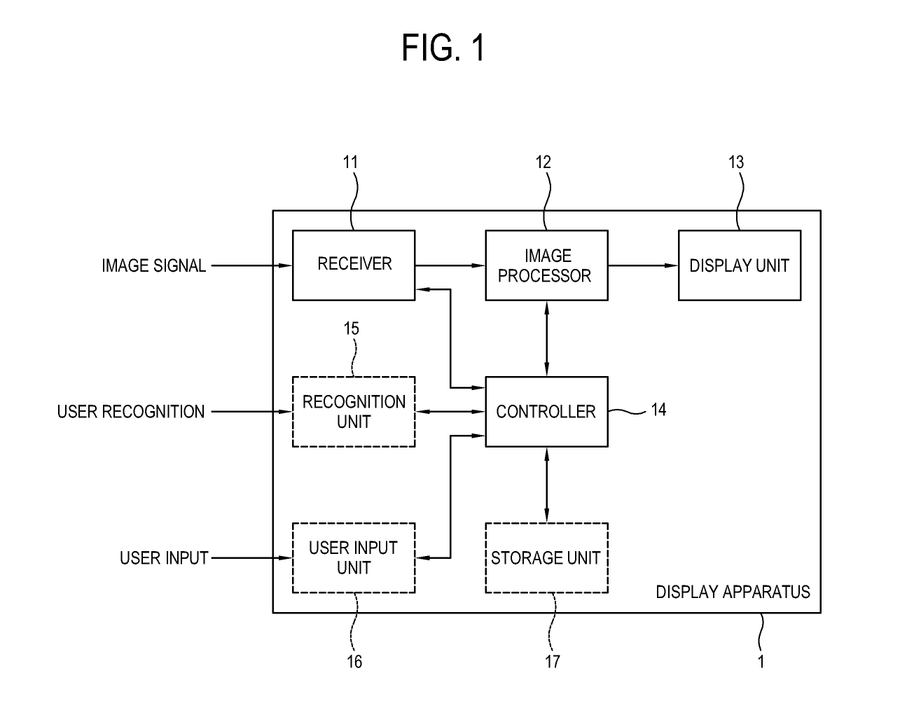

FIG. 1 is a block diagram illustrating a configuration of a display apparatus according to an exemplary embodiment. The display apparatus 1 may be, for example, a TV, a PC having a display unit, a mobile phone, a smartphone or a smart pad. The display apparatus 1 includes a receiver 11, an image processing unit 12, a display unit 13 and a controller 14.

The receiver 11 receives an image signal. The receiver 11 may receive a broadcast signal from a broadcast signal transmission device (not shown), e.g., a TV broadcast signal, as an image signal, receive an image signal from an imaging device, such as a DVD player and a BD player, receive an image signal from a PC, receive an image signal from mobile equipment, such as a smartphone and a smart pad, receive an image signal through a network, such as the Internet, or receive input of image content stored in a storage medium, such as a USB storage medium, as an image signal.

The image processor 12 processes an image signal received by the receiver 11 to display an image. The image processing unit 12 performs a process to display a user interface (UI) for interfacing with a user.

The display unit 13 displays an image based on an image signal processed by the image processor 12. The display unit 13 displays a UI processed by the image processor 12.

The controller 14 determines a size of a UI displayed on the display unit 13 considering a user currently watching the display apparatus 1 and controls the display unit 13 to display the UI in a determined size. That is, the controller 14 recognizes interfacing capability of the user currently watching the display apparatus 1 and displays the UI in an appropriate size for the interfacing capability of the user on the display unit 13. For example, when the size of the currently displayed UI to the user is determined to be small, the controller 14 increases the size of the UI suitably for the user. On the contrary, when the size of the currently displayed UI is large for the user, the controller 14 decreases the size of the UI.

In the present exemplary embodiment, the UI is a graphic user interface (GUI), which may include an element for interfacing with the user, e.g., a window, a menu item, an icon, a scroll bar, a text and an image. In the present exemplary embodiment, the size of the UI includes sizes of all elements to constitute the UI, e.g., a window, a menu item, an icon, a scroll bar, a text or an image of the UI to be displayed. The controller 14 may apply the same determined size to all elements of the UI. For example, the controller 14 scales the entire UI to be large or small. Alternatively, the controller 14 increases or decreases size of only part of the elements constituting the UI. For example, the controller 14 does not scale a size of a UI window but increases or decreases sizes of only some elements included in a UI, e.g., a text, a menu item or an image. Hereinafter, exemplary embodiments with respect to the size of the UI may be applied to both the size of the entire UI and the size of each individual element constituting the UI.

The controller 14 may include a non-volatile memory (not shown) storing control programs enabling such control operations, a volatile memory (not shown) loading at least part of the stored control programs and a microprocessor (not shown) executing the loaded control program.

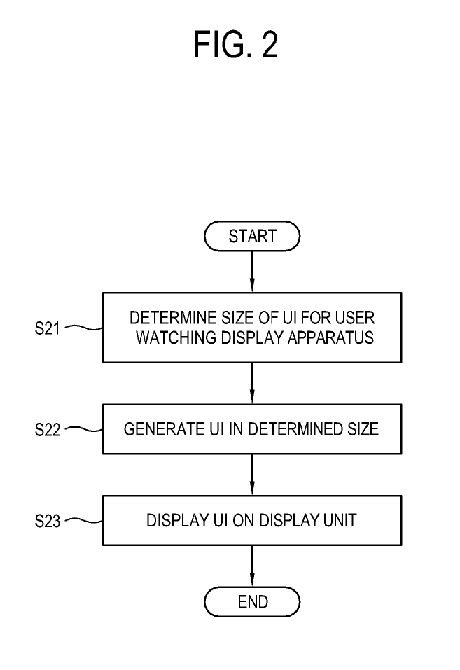

FIG. 2 is a flowchart illustrating a control method of the display apparatus 1 shown in FIG. 1 according to one exemplary embodiment. At operation S21, the display apparatus 1 determines size of a UI considering a user currently watching the display apparatus 1. For example, the display apparatus 1 may determine the size of the UI considering a user's age. Next, at operation S22, the display apparatus 1 generates the UI in a determined size. At operation S23, the display apparatus 1 displays the generated UI on the display unit 13.

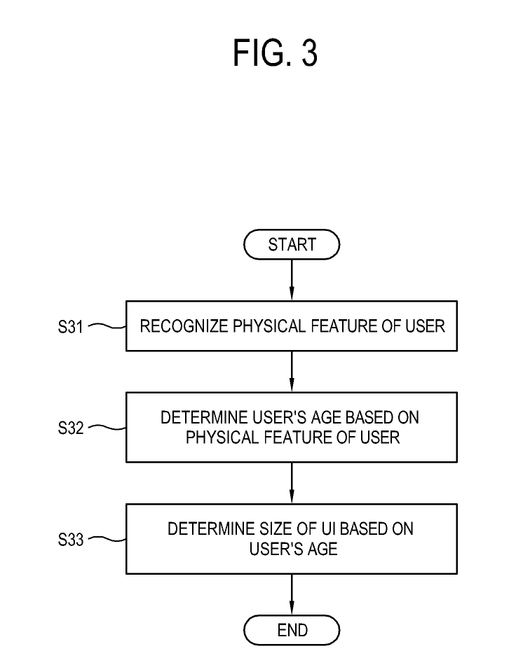

FIG. 3 is a flowchart illustrating a control method of the display apparatus 1 shown in FIG. 1 according to one exemplary embodiment. At operation S31, the display apparatus 1 recognizes a physical feature of a user. In this case, the display apparatus 1 may further include a recognition unit 15 to detect the physical feature of the user as shown in FIG. 1. The recognition unit 15 may be configured as, for example, an image sensor or a voice recognition sensor, which may receive an image of user's appearance or user's voice.

At operation S32, the display apparatus 1 determines user's age based on the detected physical feature of the user. For example, the display apparatus 1 recognizes the user's age based on an image or voice of the user received by the recognition unit 14. At operation S33, the display apparatus 1 determines size of the UI based on user's age. For example, the display apparatus 1 may increase the size of the UI considering that an older user may have lower interfacing capability.

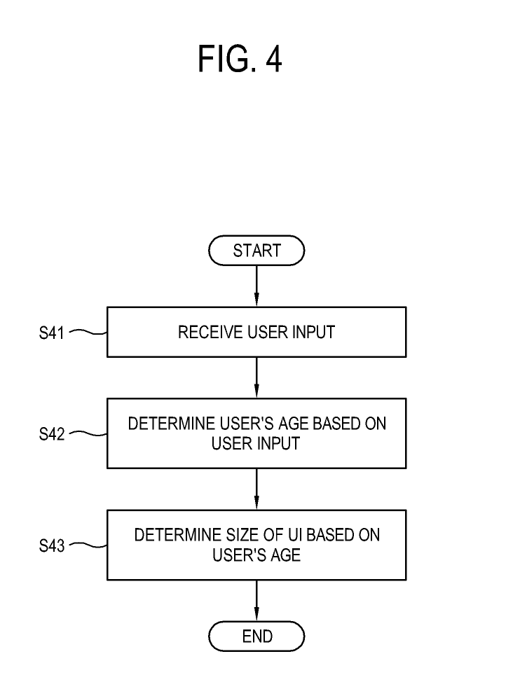

FIG. 4 is a flowchart illustrating a control method of the display apparatus 1 shown in FIG. 1 according to one exemplary embodiment. At operation S41, the display apparatus 1 receives user input to determine a size of a UI. As shown in FIG. 1, the display apparatus 1 may further include a user input unit 16 to receive user input. At operation S42, the display apparatus 1 determines a user's age based on the user input. For example, the user may input his/her own age. At operation S43, the display apparatus 1 may determine the size of the UI based on the user's age.

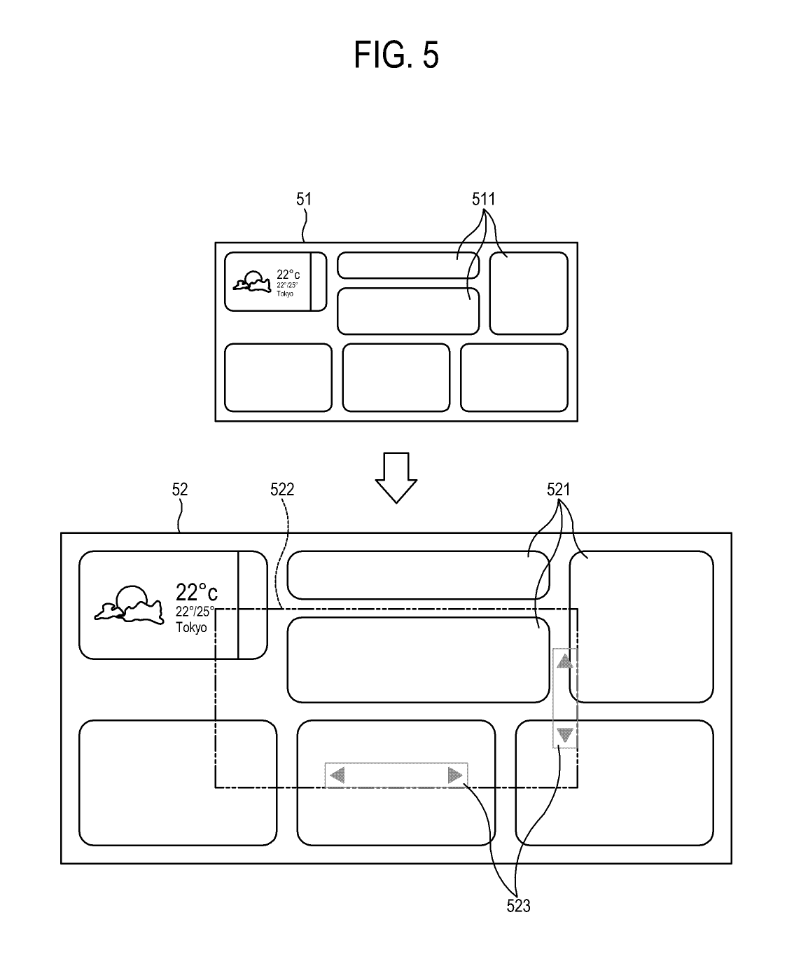

FIG. 5 is an illustrative example of a UI displayed on the display unit 13 of the present exemplary embodiment. In FIG. 5, reference numeral 51 indicates a UI before scaling and reference numeral 52 indicates the UI after scaling for a user currently watching the display apparatus 1. The display apparatus 1 identifies the user currently watching the display apparatus 1 while displaying the UI 51 before scaling. The display apparatus 1 determines the size of the UI based on the user. If the currently displayed UI 51 has an inappropriately small size for the user, the display apparatus 1 increases the size of the UI 51 appropriately for the user and displays the scaled UI 52. As shown in FIG. 5, various menu items 511 included in the UI 51 before scaling are enlarged to appropriate sizes 521 for the user in the UI 52. FIG. 5 shows just one illustrative example of scaling the entire UI, without being limited thereto. For example, part of the elements forming the UI may be scaled. In this manner, the UI may be scaled to an appropriate size for a user who has bad sight or is poor at manipulation of the UI, such as an old person, and thus readability and manipulation of the UI for the user may be improved.

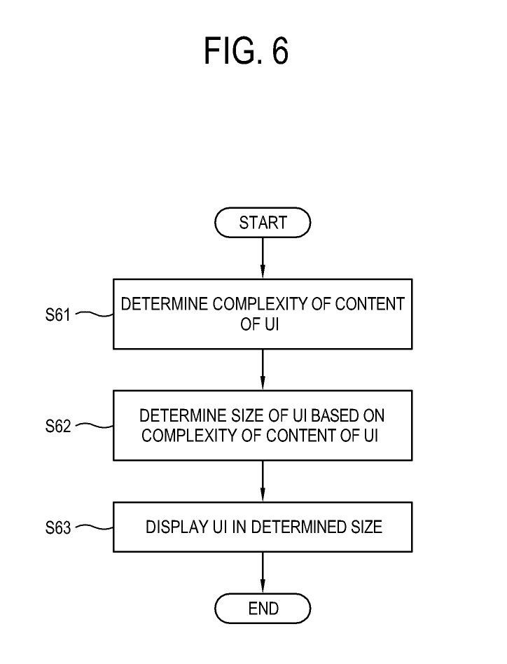

FIG. 6 is a flowchart illustrating a control method of the display apparatus 1 shown in FIG. 1 according to one exemplary embodiment. At operation S61, the display apparatus 1 determines complexity of content of a displayed UI. For example, if the content of the UI requires a level of readability, such as a text and a webpage, the display apparatus 1 determines that the complexity of the content of the UI is high. Further, if the content of the UI is easy for the user to understand, such as an image and a picture, the display apparatus 1 determines that the complexity of the content of the UI is low. The complexity of the content of the UI may also be determined based on a size of a UI element, such as a text and an image. For example, if a text or an image has a small size, the display apparatus 1 determines that the complexity of the content of the UI is high.

Next, at operation S62, the display apparatus 1 determines size of the UI based on the determined complexity of the content of the UI. The higher the complexity of the content of the UI is, the larger the size of the UI is. The display apparatus 1 may determine the size of the UI based on both a user currently watching the display apparatus 1 and the complexity of the content of the UI. At operation S63, the display apparatus 1 displays the UI in the determined size.

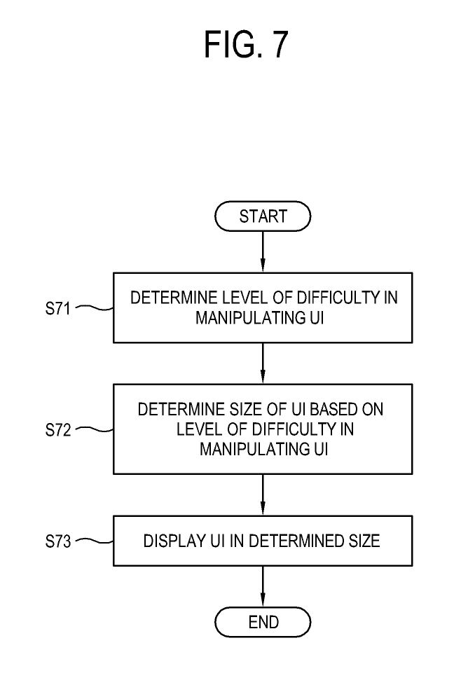

FIG. 7 is a flowchart illustrating a control method of the display apparatus 1 shown in FIG. 1 according to one exemplary embodiment. At operation S71, the display apparatus 1 determines a level of difficulty in manipulating a displayed UI. For example, when the UI includes a complicated menu item requiring a user having a level of manipulation skill, the display apparatus 1 determines that the level of the difficulty in manipulating the UI is high. On the contrary, if the UI includes a text or an image only, which does not need a user's manipulation, or contains a simple menu item, the display apparatus 1 determines that the level of the difficulty in manipulating the UI is low.

At operation S72, the display apparatus 1 determines a size of the UI based on the determined level of difficulty in manipulating the UI. The higher the level of difficulty in manipulating the UI is, the larger the size of the UI is made. The display apparatus 1 may determine the size of the UI considering all or at least two among a user currently watching the display apparatus 1, the complexity of the content of the UI and the level of the difficulty in manipulating the UI. At operation S73, the display apparatus 1 displays the UI in the determined size.

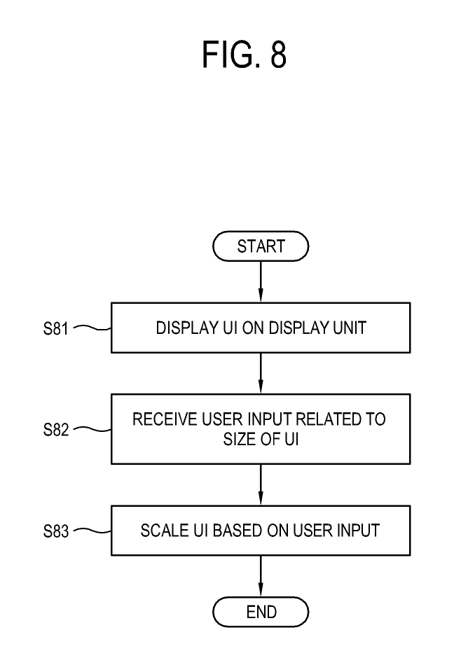

FIG. 8 is a flowchart illustrating a control method of the display apparatus 1 shown in FIG. 1 according to one exemplary embodiment. At operation S81, the display apparatus 1 displays a UI on the display unit 13. For example, the display apparatus 1 may display the UI 52 shown in FIG. 5. At operation S82, the display apparatus 1 receives user input related to size of the UI. At operation S83, the display apparatus 1 scales the UI 52 based on the user input. In this case, the display apparatus 1 may display a screen region 522 of the display unit 13 for a user to adjust the relative size of the UI 52 to a screen of the display unit 13. Further, the display apparatus 1 may further display a scroll bar 523 for the user to adjust a position of the UI on the screen of the display unit 13. In this way, the user adjusts the size and position of the UI at discretion, thus improving user convenience.

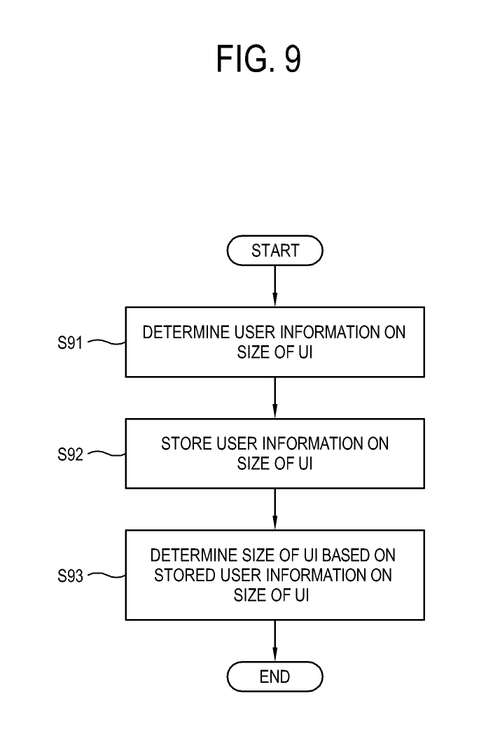

FIG. 9 is a flowchart illustrating a control method of the display apparatus 1 shown in FIG. 1 according to one exemplary embodiment. At operation S91, the display apparatus 1 determines user information on size of a UI. The user information on the size of the UI may be, for example, information recognized and determined with the recognition unit 15, e.g., user's age, or information input by a user through the user input unit 16.

At operation S92, the display apparatus 1 stores the determined user information on the size of the UI. The display apparatus 1 may further include a storage unit 17 storing the user information on the size of the UI, shown in FIG. 1. The storage unit 17 is a nonvolatile memory, which may be configured as a ROM, a flash memory, or a hard disk.

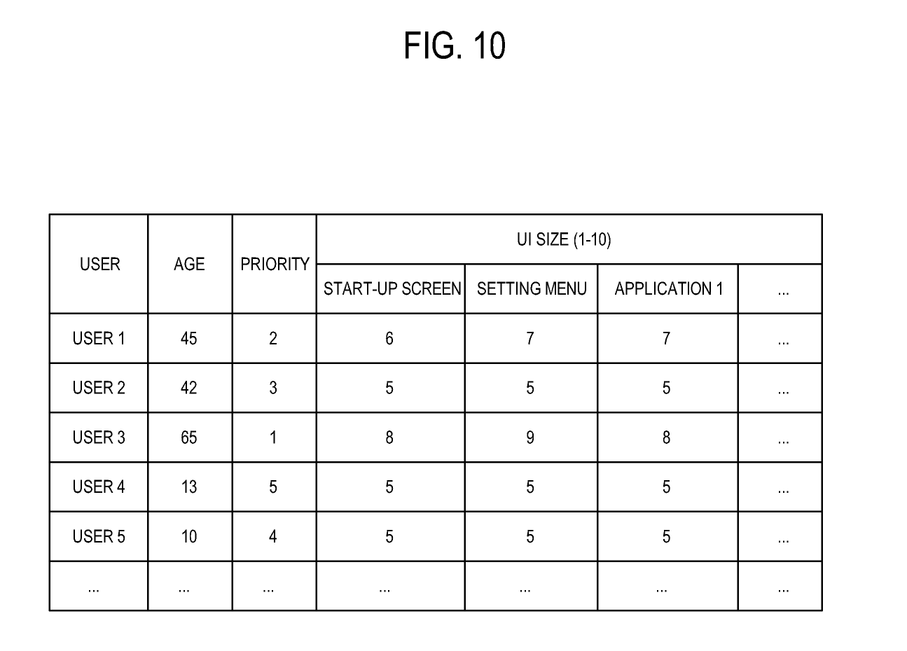

FIG. 10 is an illustrative example of the user information on the size of the UI stored in the storage unit 17. For example, the user information on the size of the UI may include a user name (“user”), user's age (“age”) and an appropriate UI size for the user (“UI size”). A plurality of information on the size of the UI may be provided corresponding to each type of a UI (“start-up screen,” “setting menu,” “application 1,” etc.). In the present exemplary embodiment, the size of the UI is divided into ten levels from the smallest level 1 to the largest level 10. The user information may be obtained by recognition by the display apparatus 1 or input by the user.

Referring back to FIG. 9, at operation S93, the display apparatus 1 determines the size of the UI based on the user information on the size of the UI stored in the storage unit 17. For example, referring to the user information shown in FIG. 10, when a user currently watching the display apparatus 1 is user 2, the display apparatus 1 displays a UI of setting menu in a size of level 5 set up for user 2. Also, when a user currently watching the display apparatus 1 is user 3, the display apparatus 1 displays a UI of application 1 in a size of level 8 set up for user 3. In this case, characteristics of the user currently watching the display apparatus 1 may be determined by recognition by the display apparatus 1 or input by the user.

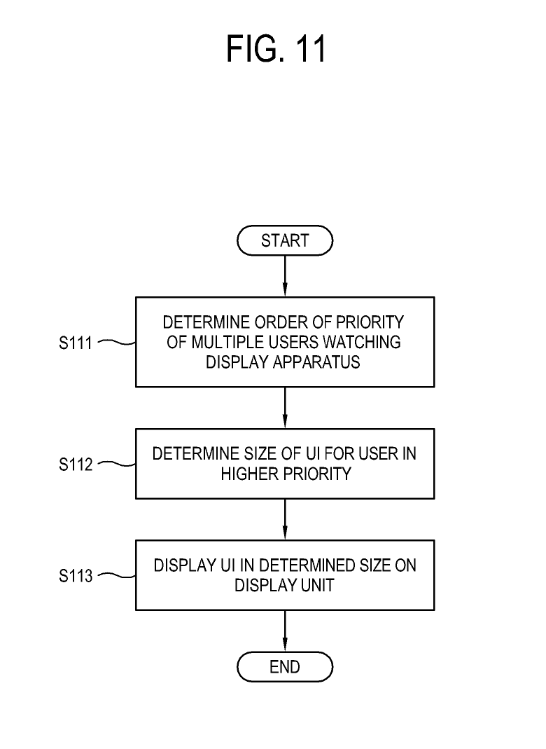

FIG. 11 is a flowchart illustrating a control method of the display apparatus 1 shown in FIG. 1 according to one exemplary embodiment. In the present exemplary embodiment, a plurality of users watch the display apparatus 1. At operation S111, the display apparatus 1 determines order of priority of the users. The order of priority of the users may be determined in advance. For example, as shown in FIG. 10, information on the order of priority of the users (“priority”) may be stored in the storage unit 17. If user 1, user 3 and user 5 are watching the display apparatus 1, the display apparatus 1 may determine user 3 as a highest priority.

At operation S112, the display apparatus 1 determines size of the UI appropriately for the user in the highest priority among the users. In the foregoing example, since user 3 is in the highest priority among the users, the display apparatus 1 determines the size of a UI of setting menu as level 9 set up for user 3. At operation S113, the display apparatus 1 displays the UI in a determined size of level 9.

Alternatively, when the information on the users currently watching the display apparatus 1 is not stored in the storage unit 17, the display apparatus 1 displays the UI in a default size. In this case, the display apparatus 1 recognizes age of a user currently watching the display apparatus 1 using the recognition unit 15 and displays the UI in a default size set up in advance for the corresponding age. Next, the display apparatus 1 asks the user whether the displayed size of the UI is appropriate. If the size is not appropriate, the display apparatus 1 may scale the UI based on user input. In this case, the display apparatus 1 stores information on the adjusted size of the UI in the storage unit 17 as information on the corresponding user, and displays the UI in the proper size using the stored information when the corresponding user watches the display apparatus 1 the next time.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
an image processor which processes an image signal;
a display unit which displays an image based on the image signal and a user interface (UI) for user interfacing; and
a controller which determines a size of the UI displayed on the display unit for a user currently watching the display apparatus and which displays the UI in the determined size on the display unit.

2. The display apparatus of claim 1, wherein the controller determines the size of the UI based on an age of the user.

3. The display apparatus of claim 2, further comprising a recognition unit which recognizes a physical feature of the user, wherein the controller determines the age of the user based on the physical feature of the user.

4. The display apparatus of claim 2, further comprising a user input unit which receives user input, wherein the controller determines the age of the user based on the user input.

5. The display apparatus of claim 1, wherein the controller determines the size of the UI based on complexity of content of the UI.

6. The display apparatus of claim 1, wherein the controller determines the size of the UI based on a level of difficulty in manipulating the UI.

7. The display apparatus of claim 1, further comprising a user input unit which receives user input, wherein the controller determines the size of the UI based on the user input.

8. The display apparatus of claim 1, further comprising a storage unit which stores user information on the size of the UI, wherein the controller determines the size of the UI based on the stored user information.

9. The display apparatus of claim 8, wherein the controller determines the size of the UI for a user in a higher priority among a plurality of users when the plurality of users watch the display apparatus.

10. A control method of a display apparatus displaying an image, the control method comprising:
determining a size of a user interface (UI) to be displayed on a display unit for a user currently watching the display apparatus;
generating the UI in the determined size; and
displaying the UI on the display unit.

11. The control method of claim 10, wherein the determining the size of the UI comprises determining the size of the UI based on an age of the user.

12. The control method of claim 11, further comprising recognizing a physical feature of the user, wherein the determining the size of the UI comprises determining the age of the user based on the physical feature of the user.

13. The control method of claim 11, further comprising receiving user input, wherein the determining the size of the UI comprises determining the age of the user based on the user input.

14. The control method of claim 10, wherein the determining the size of the UI comprises determining the size of the UI based on complexity of content of the UI.

15. The control method of claim 10, wherein the determining the size of the UI comprises determining the size of the UI based on a level of difficulty in manipulating the UI.

16. The control method of claim 10, further comprising receiving user input, wherein the determining the size of the UI comprises determining the size of the UI based on the user input.

17. The control method of claim 10, further comprising storing user information on the size of the UI, wherein the determining the size of the UI comprises determining the size of the UI based on the stored user information.

18. The control method of claim 10, wherein the determining the size of the UI comprises determining the size of the UI for a user of a higher priority among a plurality of users when the plurality of users watch the display apparatus.
